(19) United States
(12) Patent Application Publication
(10) Pub. No.: US 2007/0171180 A1
(43) Pub. Date: Jul. 26, 2007

(54) Light source driving circuit, lighting apparatus, display apparatus, field sequential color liquid crystal display apparatus, and information appliance

(76) Inventor: Takashi Akiyama, Saitama (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 10/589,355

(22) PCT Filed: Feb. 10, 2005
(86) PCT No.: PCT/JP05/02506

§ 371 Date: Aug. 11, 2006

(30) Foreign Application Priority Data
Feb. 12, 2004 (JP) 2004-034338

(51) Int. Cl. G09G 3/36

(52) U.S. Cl. 345/102

(57) ABSTRACT

The invention provides a light source driving circuit that can enhance a power supply efficiency while permitting reductions in the size and the noise of the power supply, and also provides a lighting apparatus, a display apparatus, a field-sequential-color liquid crystal display apparatus, and an information appliance that use such a light source driving circuit. The light source driving circuit includes a power supply section, a light source section, a charging section for storing an electric charge provided from the power supply section; a switching section for connecting the charging section to the power supply section or to the light source section, and a control section for controlling the switching section so as to connect the charging section to the power supply section, thereby charging the charging section, and so as to disconnect the charging section from the power supply section and connect the charging section to the light source section, thereby causing the light source section to emit light.

### FIELD OF THE INVENTION

The present invention relates to a light source driving circuit, and also relates to a lighting apparatus, a display apparatus, a field sequential color liquid crystal display apparatus, and an information appliance that uses such a light source driving circuit.

### BACKGROUND OF THE INVENTION

Display apparatuses employing the field sequential color (hereinafter abbreviated FSC) technique which displays a color image by sequentially emitting light sources of three original colors have been attracting attention in recent years.

In the backlight system (an LED driving circuit) used for such an FSC display apparatus (for example, refer to JP-A-H6-186528), light-emitting diodes (hereinafter abbreviated LEDs) have been used as light-emitting devices in the light source. In the backlight system for the FSC display apparatus, it has been practiced to connect each LED to a power supply during the light emitting period of the light source and drive the LED directly from the power supply. However, in the backlight system for the FSC display apparatus, the light sources of the three original colors have to be emitting sequentially in an alternating drive and, because of the need to avoid color mixing, the light sources have had to be deactivated (turned off the light) for the period during which data is being written to the display device. Accordingly, the duty ratio of each light source is small, and a large current has had to be passed through the light source during the light emitting period in order to obtain a desired brightness.

FIG. 14 shows one example of the above-described LED driving circuit.

As shown in FIG. 14A, the power supply 10 is connected to the LED 12 in the light source via a switch 18 which is turned on and off under the control of a CK signal. FIG. 14B is a diagram showing the timing waveform of the clock signal (CK signal) that defines the light emitting timing for the LED 12. As shown in FIG. 14B, when the CK signal is at an H level, the switch 18 is ON, and the current from the power supply 10 flows. directly to the LED 12 in the light source, causing the light-emitting device 12 to emit light. When the CK signal is at an L level, the switch 18 is OFF, and the power supply 10 is disconnected from the light-emitting device 12 in the light source, thus deactivating the LED 12. In FIG. 14B, period t14 indicates the period during which the light-emitting devices of the other original colors are emitting light or data is being written to the display device. As shown in FIG. 14B, the period t12 during which the CK signal is at the H level is shorter than the period t14 during which the CK signal is at the L level. Accordingly, to obtain the desired brightness, the LED 12 has had to be operated to produce higher brightness by passing a large current through the light-emitting device 12 during the period t12 than would be the case if the LED 12 were constantly held ON. More specifically, the current has had to be increased by a factor of (t14+t12)/t12 compared with the case if the LED 12 were constantly held ON. Here, t14+t12 represents the repetition period T. When T is constant, the above factor tends to increase as the number of pixels of the display apparatus increases, because the time required to write data to the display device increases as the number of pixels of the display apparatus increases.

However, at first, there has been the problem that a power supply having a capacity large enough to supply a large instantaneous current is difficult to reduce in size. Second, there has been the problem that, in the case of a large capacity power supply, the reactive power is large and it is difficult to achieve a high-efficiency power supply. Third, there has been the problem that a large current causes power supply noise, such as a supply voltage drop, to reduce the system noise margin and adversely affect the receiver functions of portable telephones and televisions. The reactive power mentioned here corresponds to the loss due to the self power consumption and internal resistance of the power supply, represented by Vin×Iin−Vout×Iout, where Vin is the input voltage to the power supply, Iin is the input current, Vout is the output voltage from the power supply, and Iout is the output current.

FIG. 15 shows another example of the light source driving circuit (for an example, refer to JP-A-H9-97925).

In FIG. 15, the same parts as those in FIG. 14 are designated by the same reference numerals. The light source driving circuit shown in FIG. 15 includes switches 84 and 86 controlled in interlinking fashion and a capacitor 88. When the switches 84 and 86 are connected to contacts “a”, a current flows from the power supply 10 through the path provided by the switch 84, the capacitor 88, and the switch 86, and the capacitor 88 is thus charged to approximately the same voltage as the supply voltage of the power supply 10. On the other hand, when the switches 84 and 86 are connected to contacts “b”, the power supply 10, the capacitor 88, and the LED 12 are connected in series. As a result, the sum of the supply voltage of the power supply 10 and the voltage stored on the capacitor 88 is applied to the LED 12, and a current flows causing the LED 12 to emit light.

Here, it is assumed that the threshold voltage (hereinafter abbreviated Vth) at which the light-emitting device 12 in the light source begins to emit light with prescribed brightness is larger than the supply voltage of the power supply 10 but smaller than twice the supply voltage of the power supply 10. The light source driving circuit shown in FIG. 15 is one that proposes a method for driving a light-emitting device, such as an organic EL, whose Vth is larger than the supply voltage. However, in the light source driving circuit shown in FIG. 15 also, when driving the light-emitting device, the current is passed through the light-emitting device 12 via the power supply 10 which is thus required to pass a large instantaneous current. Accordingly, in the light source driving circuit shown in FIG. 15 also, none of the earlier described problems are solved.

FIG. 16 shows still another example of the light source driving circuit (for example, refer to JP-A-2001-144597).

In FIG. 16, the same parts as those in FIG. 14 are designated by the same reference numerals. The light source driving circuit shown in FIG. 16 includes switches 90 and 91 controlled in an interlinked fashion, a capacitor 92, and a constant-current circuit 96. When the switches 90 and 91 are connected to contacts “a”, a constant current flows from the power supply 10 through the path provided by the switch 90, the capacitor 92, the switch 91, and the constant-current circuit 96, and the capacitor 92 is thus charged to approximately the same voltage as the supply voltage of the power supply 10. On the other hand, when the switches 90 and 91 are connected to contacts “b”, the power supply 10, the capacitor 92, the LED 12, and the constant-current circuit 96 are connected in series; as a result, the sum of the supply voltage of the power supply 10 and the voltage stored on the capacitor 92 is applied to the LED 12, causing the LED 12 to emit light.

The purpose of the light source driving circuit shown in FIG. 16 is to stabilize the emitting of light in a light transmission system. It is assumed here that the threshold voltage Vth at which the LED 12 begins to emit light with prescribed brightness is larger than the supply voltage of the power supply 10 but smaller than twice the supply voltage of the power supply 10. This assumption is the same as that used for the light source driving circuit shown in FIG. 15. In the light source driving circuit shown in FIG. 16, the constant-current circuit 96 acts to prevent the instantaneous current from becoming larger than necessary and thus serves to stabilize the emitting of light.and prevent the noise margin in the power supply from decreasing. However, when driving the LED 12, the current is passed through the LED 12 via the power supply 10 which is thus required to pass a large current. Further, the constant-current circuit 96 requires that the power supply 10 be capable of supplying a current higher in value than the current to be controlled, and therefore, the capacity of the power supply must be increased. Accordingly, in the light source driving circuit shown in FIG. 16 also, neither the problem that it is difficult to reduce the size of the power supply, nor the problem that it is difficult to achieve a high-efficiency power supply, is solved.

FIG. 17 shows an example of a lighting apparatus (for an example, refer to JP-A-H8-203688).

In FIG. 17, the same parts as those in FIG. 14 are designated by the same reference numerals. In the lighting apparatus shown in FIG. 17, a very high voltage is generated by a voltage raising circuit 97, and this high voltage is supplied, via a diode 98, to charge a main capacitor 99. The charge stored on the main capacitor 99 is discharged into a camera flash 112, causing it to flash. The main purpose of the lighting apparatus shown in FIG. 17 is to stop the voltage raising by the voltage raising circuit 97 when the supply voltage of the power supply 10 drops and thereby to prevent an ill effect from being caused in the system.

If the lighting apparatus shown in FIG. 17, which uses the diode 98, not a switch, is applied to a low-voltage lighting apparatus designed to drive an LED as in the present invention, the current from the power supply cannot be prevented from flowing into the LED. Furthermore, in the lighting apparatus shown in FIG. 17, as the amount of current is not limited when charging the main capacitor 99, a large instantaneous current can flow into the circuit. Further, as the main capacitor 99 is charged via the diode 98, if the lighting apparatus shown in FIG. 17 is applied to a low-voltage system, power is wasted due to the forward voltage of the diode when charging the capacitor, and hence the problem that the power supply cannot be used efficiently occurs. Accordingly, in the lighting apparatus shown in FIG. 17 also, none of the earlier described problems are solved.

### SUMMARY OF THE INVENTION

It is an object of the present invention to provide a light source driving circuit that solves the above-described problems, and also to provide a lighting apparatus, a display apparatus, a field sequential color liquid crystal display apparatus, and an information appliance that use such a light source driving circuit.

It is another object of the present invention to provide a light source driving circuit that can reduce the size of a power supply, and also to provide a lighting apparatus, a display apparatus, a field-sequential-color liquid crystal display apparatus, and an information appliance that uses such a light source driving circuit.

It is still another object of the present invention to provide a light source driving circuit that can reduce power supply noise, and also to provide a lighting apparatus, a display apparatus, a field sequential color liquid crystal display apparatus, and an information appliance that use such a light source driving circuit.

It is a further object of the present invention to provide a light source driving circuit that can enhance power supply efficiency, and also to provide a lighting apparatus, a display apparatus, a field sequential color liquid crystal display apparatus, and an information appliance that use such a light source driving circuit.

It is a still further object of the present invention to provide a light source driving circuit that can enhance power supply efficiency while permitting reductions in size and noise of the power supply, and also to provide a lighting apparatus, a display apparatus, a liquid crystal display apparatus employing a field sequential color system, and an information appliance that use such a light source driving circuit.

A light source driving circuit according to the present invention includes a power supply section, a light source section, a charging section for storing an electric charge provided from the power supply section; a switching section for connecting the charging section either to the power supply section or to the light source section, and a control section for controlling the switching section so as to connect the charging section to the power supply section, thereby charging the charging section, and so as to disconnect the charging section from the power supply section and connect the charging section to the light source section, thereby causing the light source section to emit light.

Preferably, in the light source driving circuit according to the present invention, a non-emitting period, which includes a period during which the charging section is connected to the power supply section for charging, is set longer than an emitting period during which the light source section is caused to emit light.

Preferably, in the light source driving circuit according to the present invention, the switching section includes a first switch and a second switch, wherein the power supply section is connected to the charging section via the first switch, and the light source section is connected to the charging section via the second switch.

Preferably, in the light source driving circuit according to the present invention, the first switch and the second switch each have a control terminal, wherein the first switch and the second switch are controlled so as to conduct cyclically in an alternating drive by a control signal that the control section applies to each control terminal.

Preferably, in the light source driving circuit according to the present invention, the power supply section includes a constant-current circuit, wherein the power supply section charges the charging section via the constant-current circuit.

Preferably, in the light source driving circuit. according to the present invention, the charging section includes a driving capacitor.

Preferably, in the light source driving circuit according to the present invention, the light source section includes a light-emitting diode.

Preferably, in the light source driving circuit according to the present invention, the light source section includes a first light source for emitting first. color light, a second light source for emitting second color light, and a third light source for emitting third color light, and the switching section includes a first switch, a second switch, a third switch, and a fourth switch, wherein the power supply section is connected to the charging section via the first switch, the first light source is connected to the charging section via the second switch, the second light source is connected to the charging section via the third switch, and the third light source is connected to the charging section via the fourth switch. In this configuration, one charging capacitor is used to drive three LEDs which emit light, for example, in three different colors.

Preferably, in the light source driving circuit according to the present invention, the first switch, the second switch, the third switch, and the fourth switch each have a control terminal, wherein the first switch, the second switch, the third switch, and the fourth switch are controlled so as to conduct cyclically in an alternating drive by a control signal that the control section applies to each control terminal.

Preferably, in the light source driving circuit according to the present invention, the light source section includes a first light source for emitting first color light, a second light source for emitting second color light, and a third light source for emitting third color light, the charging section includes a first driving capacitor corresponding to the first light source, a second driving capacitor corresponding to the second light source, and a third driving capacitor corresponding to the third light source, and the switching section includes a first switch, a second switch, a third switch, a fourth switch, a fifth switch, and a sixth switch, wherein the power supply is connected to the first driving capacitor via the first switch, the power supply is connected to the second driving capacitor via the second switch, the power supply is connected to the third driving capacitor via the third switch, the first light source is connected to the first driving-capacitor via the fourth switch, the second light source is connected to the second driving capacitor via the fifth switch, and the third light source is connected to the third driving capacitor via the sixth switch. In this configuration, three charging capacitors are used corresponding to three LEDs which emit light, for example, in three different colors.

Preferably, in the light source driving circuit according to the present invention, the first switch, the second switch, the third switch, the fourth switch, the fifth switch, and the sixth switch each have a control terminal wherein the first switch, the second switch, the third switch, the fourth switch, the fifth switch, and the sixth switch are controlled so as to conduct cyclically in an alternating drive by a control signal that the control section applies to each control terminal.

A lighting apparatus according to the present invention uses the light source driving circuit according to the present invention.

A display apparatus according to the present invention uses the light source driving circuit according to the present invention.

A field sequential color liquid crystal display apparatus according to the present invention uses the light source driving circuit according to the present invention.

An information appliance according to the present invention uses the light source driving circuit according to the present invention.

A light source driving circuit according to the present invention includes a light source which is caused to emit light intermittently by an electric current supplied from a power supply, and a driving capacitor which is charged by the power supply during a non-emitting period that the light source is not emitting light wherein, in an emitting period, the light source is caused to emit light by causing the driving capacitor to discharge.

Further, a light source driving circuit according to the present invention includes a light source which is caused to emit light intermittently by an electric current supplied from a power supply, and a driving capacitor which is charged by the power supply during a non-emitting period that the light source is not emitting light, wherein the light source is caused to emit light during an emitting period by causing the driving capacitor to discharge, and wherein the power supply is connected to one terminal of the driving capacitor via a first switch, the one terminal of the driving capacitor is further connected to the light source via a second switch, the power supply is connected to one terminal of the driving capacitor via a third switch, and the one terminal of the driving capacitor is further connected to another light source via a fourth switch.

In the light source driving circuit of the present invention and the lighting apparatus, etc. using such a light source driving circuit, during the non-emitting period the charging section such as the driving capacitor is charged with a small current and, during the emitting period, supply of the current from the power supply is stopped and the light-emitting device in the light source is caused to emit light by causing the charging section to discharge within a short period of time. Accordingly, the maximum current that the power supply has to supply can be reduced, thus making it possible to reduce the size of the power supply circuit and enhance the efficiency of the power supply in the light source driving circuit of the present invention and the lighting apparatus, etc. using such a light source driving circuit. Further, in the light source driving circuit of the present invention and the lighting apparatus, etc. using such a light source driving circuit, when provisions are made to charge the driving capacitor via a constant-current circuit, there is no need to pass a large instantaneous current, and an ill effect which may be caused to the system due to a supply voltage drop can also be avoided.

In the FSC liquid crystal display apparatus, as the non-emitting period of the light source is longer than the emitting period, and the charging section can therefore be charged with a small current by utilizing the non-emitting period, the power supply capacity can be further reduced compared with the prior art system. Accordingly, the light source driving circuit of the present invention is particularly effective when applied to such an FSC liquid crystal display apparatus and an information appliance using the same. Further, the light source driving circuit of the present invention is not limited in its application to the FSC liquid crystal display apparatus, but can also be applied to an appliance that drives a light source in an intermittent manner; in that case also, a similar effect can be achieved.

Furthermore, the light source driving circuit of the present invention offers an important effect that can enhance the efficiency of the power supply, the details of which will be described later.

### BRIEF DESCRIPTION OF THE DRAWINGS

FIG. 1 is a diagram showing the basic configuration of a light source driving circuit according to a first embodiment-of the present invention.

FIG. 2 is a diagram showing examples of the waveforms of control signals in the light source driving circuit shown in FIG. 1.

FIG. 3 is a diagram showing another examples of the waveforms of the control signals in the light source driving circuit shown in FIG. 1.

FIG. 4 is a diagram showing a configuration example of a constant-current circuit in the light source driving circuit shown in FIG. 1.

FIG. 5 is a diagram showing the basic configuration of a light source driving circuit according to a second embodiment of the present invention.

FIG. 6 is a diagram showing examples of the waveforms of control signals in the light source driving circuit shown in FIG. 5.

FIG. 7A is a diagram showing the basic configuration of a light source driving circuit according to a third embodiment of the present invention, and FIG. 7B is a diagram showing examples of the waveforms of control signals in the light source driving circuit shown in FIG. 7A.

FIG. 8A is a diagram showing the basic configuration of a light source driving circuit according to a fourth embodiment of the present invention, and FIG. 8B is a diagram showing examples of the waveforms of control signals in the light source driving circuit shown in FIG. 8A.

FIG. 9 is a diagram showing the basic configuration of a light source driving circuit according to a fifth embodiment of the present invention.

FIG. 10A is a diagram showing the basic configuration of a light source driving circuit according to a sixth embodiment of the present invention, and FIG. 10B is a diagram showing examples of the waveforms of control signals in the light source driving circuit shown in FIG. 10A.

FIG. 11 is a diagram showing the basic configuration of a light source driving circuit according to a seventh embodiment of the present invention.

FIG. 12 is a diagram showing a display apparatus and a lighting apparatus that use the light source driving circuit according to the present invention.

FIG. 13 is a diagram showing an example in which the display apparatus that uses the light source driving circuit according to the present invention is used in the display section of an information appliance.

FIG. 14A is a diagram showing the basic configuration of a light source driving circuit, and FIG. 14B is a diagram showing the waveform of a control signal in the light source driving circuit.

FIG. 15 is a diagram showing the basic configuration of another light source driving circuit.

FIG. 16 is a diagram showing the basic configuration of still another light source driving circuit.

FIG. 17 is a diagram showing the basic configuration of a lighting apparatus.

### DETAILED DESCRIPTION OF THE PREFERRED EMBODIMENT

A light source driving circuit according to the present invention, and a lighting apparatus, a display apparatus, a field-sequential-color liquid crystal display apparatus, and an information appliance that use such a light source driving circuit will be described below with reference to the drawings.

The light source driving circuit according to the present invention includes a driving capacitor which is charged during a non-emitting period of a light source, and the light source is caused to emit light during an emitting period by causing the driving capacitor to discharge. The light source driving circuit according to the present invention further includes a switch which turns on and off the connection between the power supply and the driving capacitor; during the emitting period, the switch disconnects the power supply from the driving capacitor. The power supply is connected to the driving capacitor via the switch. Further, the power supply includes a constant-current circuit, and charges the driving capacitor via the constant-current circuit.

### Embodiment 1

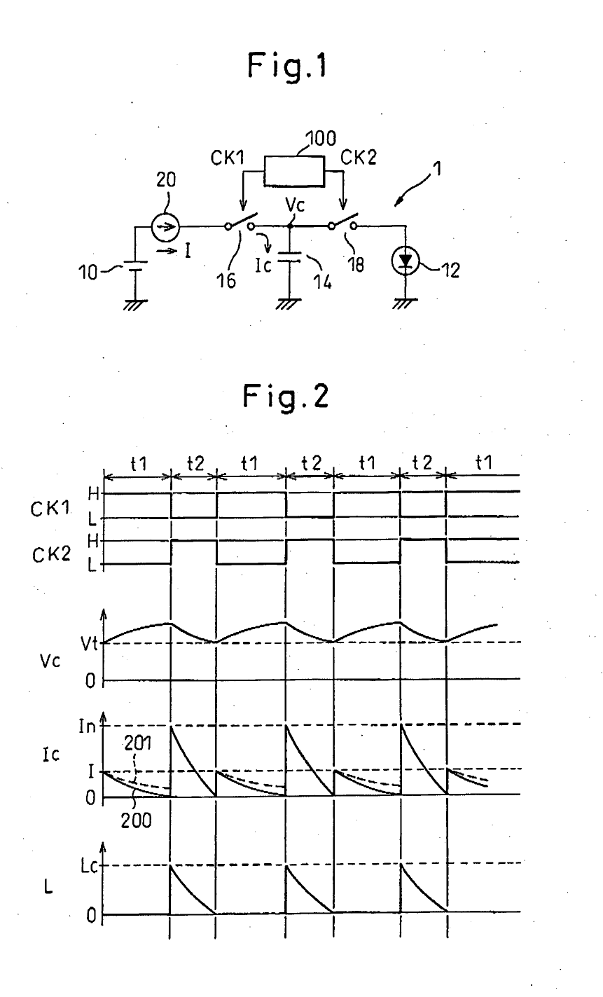

FIG. 1 shows a light source driving circuit according to a first embodiment of the present invention.

FIG. 1 is a diagram showing the basic configuration of the light source driving circuit 1 according to the first embodiment. As shown in FIG. 1, the light source driving circuit 1 comprises a power supply 10, a light-emitting device 12 as a light source, a driving capacitor 14, first and second switches 16 and 18, a constant-current circuit 20, and a control section 100 containing a CPU, etc. Here, the light-emitting device 12 as the light source is constructed from an LED.

In the light source driving circuit 1, the power supply 10 is connected to the input of the constant-current circuit 20 whose output is connected to one terminal of the first switch 16, and the other terminal of the first switch 16 is connected to one terminal of the driving capacitor 14, to which is also connected one terminal of the second switch 18; the other terminal of the second switch 18 is connected to the light-emitting device 12 in the light source. The first and second switches 16 and 18 are constructed to be turned on and off under the control of the respective control signals CK1 and CK2 supplied from the control section 100.

FIG. 2 shows examples of the waveforms of the control signals CK1 and CK2 supplied from the control section 100, along with changes in the voltage Vc on the driving capacitor 14, the current Ic flowing in the driving capacitor 14, and the luminous intensity L of the light-emitting device 12.

The control signals CK1 and CK2 are signals for controlling the on/off operations of the first and second switches 16 and 18, respectively; that is, when the signals CKl and CK2 are high (H), the respective switches are ON, and when they are low (L), the respective switches are OFF. As shown in FIG. 2, the signal CK1 is high during period t1 and low during period t2. On the other hand, the signal CK2 is high during period t2 and low during period t1. Accordingly, during the period t1, the first switch 16 is ON and the second switch 18 is OFF, and during the period t2, the first switch 16 is OFF and the second switch 18 is ON. That is, the first and second switches 16 and 18 are controlled so as to conduct (in the ON state) cyclically and in an alternating drive.

Since the first and second switches 16 and 18 are controlled as shown in FIG. 2, during the period t1 the current flows through the path provided by the power supply 10, the constant-current circuit 20, and the driving capacitor 14, and the driving capacitor 14 is thus charged. As. at this time, the charging is performed with a constant current through the constant-current circuit 20, there is no concern about the supply voltage of the power supply 10 dropping due to a large initial instantaneous current and introducing noise into the power supply system. During the period t1, as the second switch 18 is OFF, the charging system comprising the power supply 10, the constant-current circuit 20, and the driving capacitor 14 is disconnected from the light-emitting device 12 in the light source.

During the period t2, the charge stored on the driving capacitor 14 is discharged through the path provided by the driving capacitor 14 and the light-emitting device 12 in the light source, and is fed into the light-emitting device 12 which is thus caused to emit light. During the period t2, as the first switch 16 is OFF, the power supply 10 is disconnected from the light-emitting device 12 in the light source. The power supply 10 is therefore unaffected by the discharging of the charge into the light-emitting device 12 in the light source, and the system stability is thus maintained. Such a stabilized power supply is particularly useful for an information appliance, such as a portable telephone or a television, that has a receiver. Further, such a stabilized power supply is also very useful for appliances that use batteries as the power supply. In the prior art examples shown in the previously cited patent documents 1 to 4, such an advantageous effect cannot be obtained, because disconnecting means for disconnecting the light source from the power supply during the light-emitting operation of the light source is not provided.

As shown in FIG. 2, in the light source driving circuit 1, the period t1 during which the driving capacitor 14 is charged is set longer than the period t2 during which the light-emitting device 12 in the light source is emitting light. The reason for this is to allow data updates, etc. to be performed on the display device such as a liquid crystal display device during the non-emitting period t1 of the light source. If the light source were activated to emit light, for example, during the data writing period of the display device such as a liquid crystal display device, the display would be disrupted, which would not be desirable.

In particular, when the light source driving circuit 1 is used for an FSC liquid crystal display apparatus, if the light source were activated to emit light during the data writing period of the display device such as a liquid crystal display device, color mixing would occur on the display. To prevent this, the light-emitting device 12 is held in the non-emitting state during the period t1. Further, the capacitor is charged by utilizing the data writing period of the display device such as a liquid crystal display device. When the light source driving circuit 1 is used for an FSC liquid crystal display apparatus, the data update time becomes about three times longer than in the normal case (for example, the case of a single-color light source), because data of three original colors must be written serially. As a result, the period t1 becomes about three times longer than in the normal case. In the predetermined period t1+t2 called the frame period, field period, or sub-field period in the FSC liquid crystal display apparatus, as t1 becomes longer, t2 becomes shorter. The need therefore arises to operate the light-emitting device 12 to produce higher brightness by passing a larger current than in the normal case during this short light emitting period t2. This has greatly arised loads on the power supply in the prior art system. There has also been the problem that, as the number of pixels of the display apparatus increases, the data update time becomes longer and the load on the power supply increases correspondingly.

In contrast, in the light source driving circuit 1, as the driving capacitor 14 is charged with a constant current during the period t1 which is longer than the period t2, the load on the power supply is alleviated. If the period t1 is sufficiently longer than the period t2, the power supply 10 need only have a capacity comparable to that of the power supply used in the conventional system in which the light source is constantly held ON. There is therefore no need to increase the power supply capacity, and the power supply can thus be reduced in size while enhancing the efficiency.

In the case of a portable appliance, the driving capacitor 14 with a capacitance of several to several tens of microfarads, for example, about 5 microfarads, can store a sufficient amount of charge. Chip-type capacitors are available for such applications, and if a capacitor of this type is used, the size of the power supply can be reduced.

The power supply efficiency of the light source driving circuit 1 according to the first embodiment will be described below.

When the current value required to obtain a specified brightness from the light-emitting device 12 constructed from an LED is denoted by i, in order to pass the current i that the prior art required, a resistor must be connected in series to the LED to adjust the value of the current supplied to the LED. In the prior art, there have also been cases where a constant-current circuit is inserted instead of the resistor. In such prior art examples, the resistive component (or the constant-current circuit) consumes power (=resistance R×square of current value i). When the power supply is 5V, and the threshold voltage Vth of the LED is 3V, the total power is given as W=3V×i+2V×i. As a result, the power (W=2V×i) consumed by the resistor, i.e., the total power minus the power (W=3V×i) consumed by the LED, is always wasted. When the power supply is 5V, about 40% is wasted.

On the other hand, in the light source driving circuit 1 according to the first embodiment, when the total amount of charge necessary to obtain the desired LED brightness is denoted by QT, an amount of charge, Qt, is required per unit time, If the on/off duty ratio of the first and second switches 16 and 18 shown in FIG. 1 is 50%, a charge “2×Qt” needs to be supplied per unit time during the ON period of the first switch 16. When the supply voltage is 5V, and the Vth of the LED is 3V, then the capacitance necessary to store the charge “2×Qt” in the driving capacitor 14 can be calculated from the equation 2×Qt=(5V−3V)×capacitance C of driving capacitor 14. In this case, the capacitance C of the driving capacitor 14=Qt. After the charge “2×Qt” has been stored on the driving capacitor 14 during the ON period of the first switch 16, when the first switch 16 is turned off and the second switch 18 turned on, the stored charge “2×Qt” is discharged and the charge “2×Qt” flows to the LED. The power at this time can be calculated from the total amount of charge that flows during the ON period of the first switch 16.

It should be noted here that an amount of charge equivalent to 3V is always remained stored on the driving capacitor 14. The charge is supplied to the LED during the ON period of the second switch 18 but, since the Vth of the LED is 3V, when the voltage on the driving capacitor 14 drops to this voltage level, the LED is turned off and the current no longer flows. Thereupon, the supply of the charge from the driving capacitor 14 stops, and the remaining charge is thus remained stored on the driving capacitor 14. Accordingly, when the first switch 16 is turned on next time, since the voltage of 3V remains on the driving capacitor 14, it is only necessary to charge the driving capacitor 14 from 3V to 5V. In this case, since only the necessary current of a low current value is caused to flow, the power consumed by the internal resistance of the power supply can also be held to a minimum. That is, the power W can be reduced to a level necessary to activate the LED, and a waste of power does not occur as in the prior art; in this way, the efficiency can be raised close to 100%.

Actually, when the current is doubled, Vth increases from 3V to about 3.3V due to the internal resistance of the LED, and thus the efficiency drops. However, compared with the prior art example (in which the light source is driven directly from the power supply), the light source can achieve the same brightness with 66% of the power required in the prior art (3.3V×i/5×i=0.66).

As shown in FIG. 2, the voltage Vc on the driving capacitor 14 increases from the threshold voltage Vt of the light-emitting device 12 to a prescribed value due to the charging during the period t1, and then decreases to the threshold voltage Vt of the light-emitting device 12 due to the discharging during the period t2. Further, as shown by a solid line 200 in FIG. 2, the current Ic flowing in the driving capacitor 14 decreases gradually from the constant current value I of the constant-current circuit 20 during the period t1, and drops from a maximum current Im to 0 due to the discharging during the-period t2. Here, the circuit configuration of the constant-current circuit 20 may be adjusted so that the current Ic flowing in the driving capacitor 14 does not drop to 0 when it is discharged, as shown by a dotted line 201 in FIG. 2.

Further, as shown in FIG. 2, the luminous intensity of the light-emitting device 12 is held at nearly zero during the period t1, and then increases to a maximum luminous intensity Lc due to the maximum current value Im in the period t2 and thereafter decreases gradually.

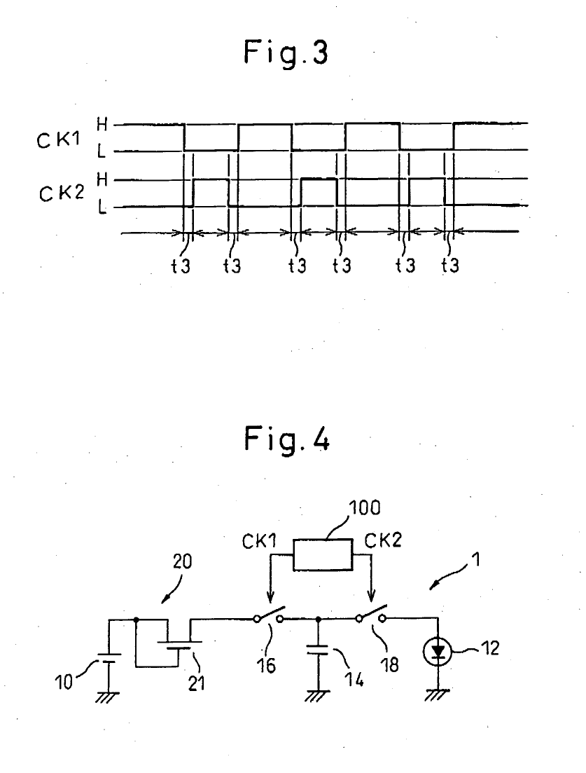

FIG. 3 shows another examples of the waveforms of the control signals CK1 and CK2 supplied from the control section 100. In FIG. 3, a period t3 is provided during which both of the first and second switches 16 and 18 are held OFF after one switch is turned off and before the other switch is turned on. The provision of the period t3 serves to prevent the occurrence of through current and to increase the stability of the power supply.

FIG. 4 shows a specific example of the constant-current circuit 20. In FIG. 4, the constant-current circuit 20 is constructed from a P-channel MOS transistor (hereinafter abbreviated PMOST) 21. As shown in FIG. 4, the gate and source of the PMOST 21 are connected together, and the source of the PMOST 21 is connected to the power supply 10, while the drain of the PMOST 21 is connected to one terminal of the first switch 16. The constant-current circuit 20 shown in FIG. 4 is only one example, and the constant-current circuit 20 may be constructed only from a resistor, or alternatively, the internal resistor of the power supply 10 may be made to act as the constant-current circuit 20. Here, the power supply 10 and the constant-current circuit 20 are together called the power supply section of the light source driving circuit 1.

The light source driving circuit 1 described above can be directly used as a lighting apparatus.

### Embodiment 2

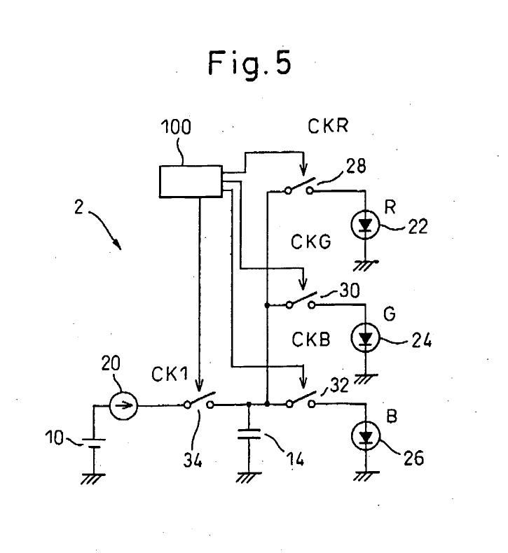

FIG. 5 shows a light source driving circuit according to a second embodiment of the present invention.

FIG. 5 is a diagram showing the basic configuration of the light source driving circuit 2 according to the second embodiment. The light source driving circuit 2 can be used for an FSC liquid crystal display apparatus. FIG. 5 differs from FIG. 1 in that, in the light source driving circuit 2 shown in FIG. 5, the light-emitting device 12 in FIG. 1 is replaced by a red (R) color LED 22, a green (G) color LED 24, and a blue (B) color LED 26, and in that the second switch 18 in FIG. 1A is replaced by a second switch 28 for the R-color LED 22, a third switch 30 for the G-color LED, and a fourth switch 32 for the B-color LED. The second switch 28 for the R-color LED 22, the third switch 30 for the G-color LED, and the fourth switch 32 for the B-color LED are constructed to be turned on and off under the control of the respective control signals CKR, CKG, and CKB supplied from the control section 100.

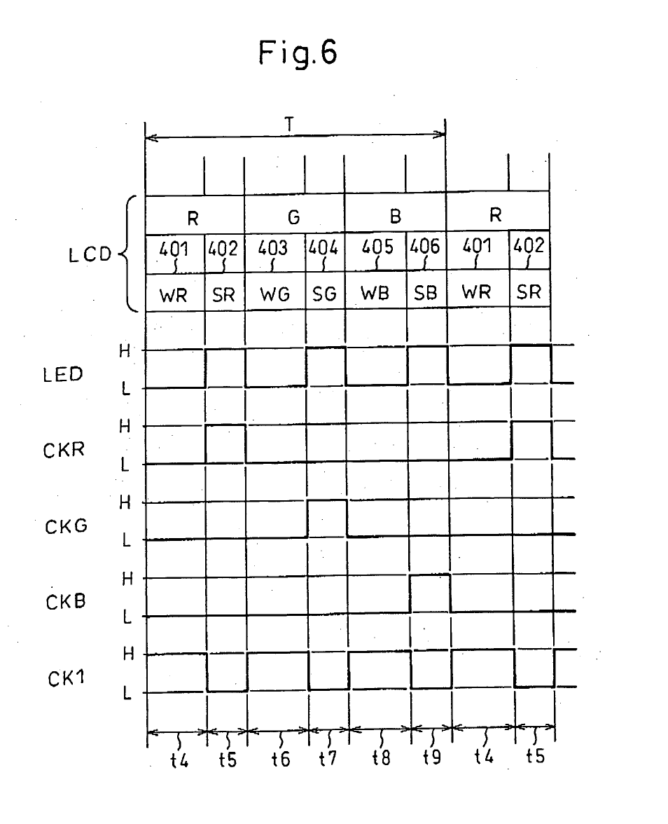

FIG. 6 shows the driving timing for the FSC liquid crystal display, along with examples of the waveforms of the control signals CKR, CKG, CKB, and CK1 supplied from the control section 100, when the light source driving circuit 2 shown in FIG. 5 is used for the FSC liquid crystal display (hereinafter abbreviated as “LCD”).

In period t4, the first switch 34 is turned on, and the driving capacitor 14 is charged using the power supply 10 and the constant-current circuit 20. During this period, the second switch 28, the third switch 30, and the fourth switch 32 are held OFF, thereby disconnecting the power supply 10, the constant-current circuit 20, and the driving capacitor 14 from the respective color LEDs 22, 24, and 26 in the light source. Here, the period t4 is the period WR (indicated by 401 in FIG. 6) for writing data to be displayed in R color on the LCD.

In the next period t5, only the second switch 28 is turned on, and the charge stored on the driving capacitor 14 is discharged into the R-color LED 22, thus causing the LED 22 to emit light. During this period, the first switch 34 is held OFF, thereby disconnecting the power supply 10, the constant-current circuit 20, and the driving capacitor 14 from the respective color LEDs 22, 24, and 26 in the light source. Accordingly, the power supply 10 and the constant-current circuit 20 are unaffected by the discharging to the LED 22, and the system is thus maintained in a stable condition. Here, the period t5 is the period SR (indicated by 402 in FIG. 6) during which an image, characters, symbols, marks, etc. (hereinafter simply referred to as the “image”) are displayed in R color on the LCD whose pixel is controlled based on the data written during the period WR.

In the next period t6, the first switch 34 is turned on, and the driving capacitor 14 is charged using the power supply 10 and the constant-current circuit 20. During this period, the second switch 28, the third switch 30, and the fourth switch 32 are held OFF, thereby disconnecting the power supply 10, the constant-current circuit 20, and the driving capacitor 14 from the respective color LEDs 22, 24, and 26 in the light source. Here, the period t6 is the period WG (indicated by 403 in FIG. 6) for writing data to be displayed in G color on the LCD.

In the next period t7, only the third switch 30 is turned on, and the charge stored on the driving capacitor 14 is discharged into the G-color LED 24, thus causing the LED 24 to emit light. During this period, the first switch 34 is held OFF, thereby disconnecting the power supply 10, the constant-current circuit 20, and the driving capacitor 14 from the respective color LEDs 22, 24, and 26 in the light source. Accordingly, the power supply 10 and the constant-current circuit 20 are unaffected by the discharging to the LED 24, and the system is thus maintained in a stable condition. Here, the period t7 is the period SG (indicated by 404 in FIG. 6) during which the image is displayed in G color on the LCD whose pixel is controlled based on the data written during the period WG.

In the next period t8, the first switch 34 is turned on, and the driving capacitor 14 is charged using the power supply 10 and the constant-current circuit 20. During this period, the second switch 28, the third switch 30, and the fourth switch 32 are held OFF, thereby disconnecting the power supply 10, the constant-current circuit 20, and the driving capacitor 14 from the respective color LEDs 22, 24, and 26 in the light source. Here, the period t8 is the period WB (indicated by 405 in FIG. 6) for writing data to be displayed in B color on the LCD.

In the next period t9, only the fourth switch 32 is turned on, and the charge stored on the driving capacitor 14 is discharged into the B color LED 26, thus causing the LED 26 to emit light. During this period, the first switch 34 is held OFF, thereby disconnecting the power supply 10, the constant-current circuit 20, and the driving capacitor 14 from the respective color LEDs 22, 24, and 26 in the light source. Accordingly, the power supply 10 and the constant-current circuit 20 are unaffected by the discharging to the LED 26, and the system is thus maintained in a stable condition. Here, the period t9 is the period SB (indicated by 406 in FIG. 6) during which the image is displayed in B color on the LCD whose pixel is controlled based on the data written during the period WB.

Thereafter, t4 to t9 are repeated, producing light in R, G, and B colors in sequence and thus accomplishing the lighting for the FSC liquid crystal display apparatus.

As in FIG. 3, in FIG. 6, an off period may be provided during which both of the first switch 34 and a corresponding one of the second, third, and fourth switches 28, 30, and 32 are held OFF. The provision of such a period serves to prevent the occurrence of through current and to increase the stability of the power supply.

In the example of FIG. 6, the charging period (t4, t6, and tB) of the driving capacitor 14 and the LCD writing period have been made to coincide with each other. However, these periods need not necessarily be made to coincide with each other, because the charging period of the driving capacitor 14 for obtaining the required luminous intensity and the LCD writing period for performing prescribed writing can vary according to the configuration, specification, etc. of the display apparatus.

In the FSC liquid crystal display apparatus, when the charging period of the driving capacitor 14, that the apparatus requires, is longer than the LCD writing period that the apparatus requires, if the LCD writing period is made to coincide with the charging period of the driving capacitor 14 that the apparatus requires, sufficient time can be allowed for writing to the LCD, the resulting effect being that a sufficient margin is allowed for the liquid crystal response time and the display characteristics further improve.

On the other hand, in the FSC liquid crystal display apparatus, when the charging period of the driving capacitor 14 that the apparatus requires is shorter than the LCD writing period that the apparatus requires, if the LCD writing period is made to coincide with the charging period of the driving capacitor 14 that the apparatus requires, sufficient time can be allowed for the charging period and the charging can therefore be performed with a low current; since the current-handling capacity of the power supply 10 and constant-current circuit 20 can be reduced, this offers the effect of being able to use a low-cost power supply.

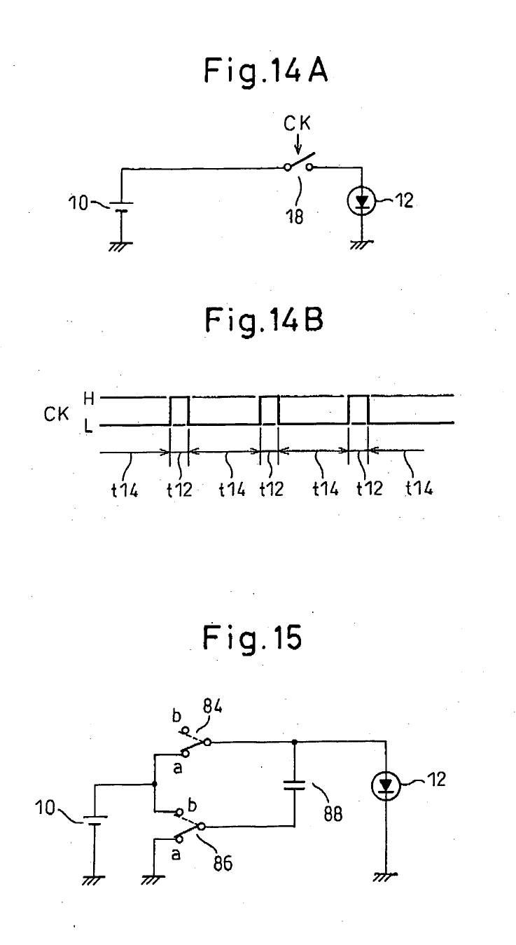

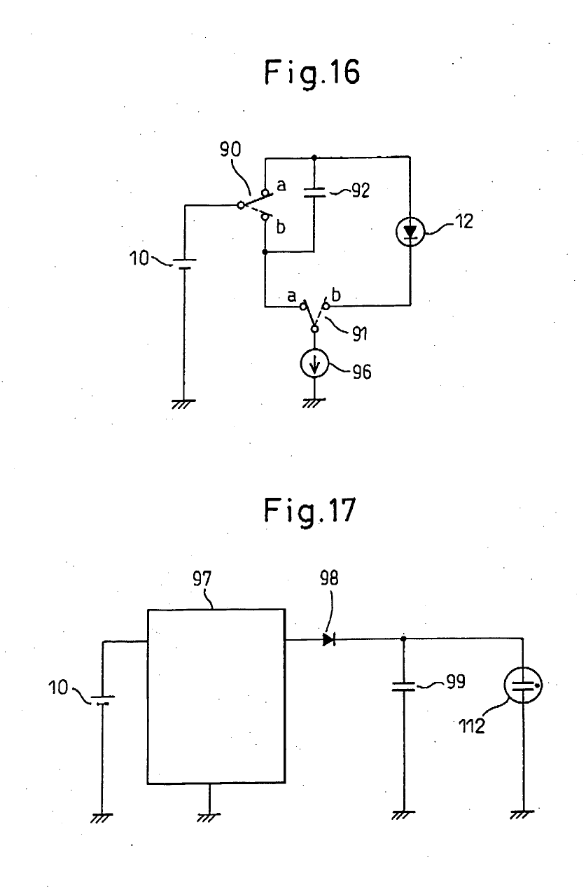

For example, suppose that, in a lighting apparatus employing an “always on” method in which one LED in the light source is always on, suitable brightness can be obtained when a current of 20 mA is passed through the LED. On the other hand, in a lighting apparatus in which the light source is caused to emit light intermittently with the ratio of the non-emitting period to the emitting period being 2 to 1 (the duty ratio of the emitting is ⅓), if the light emitting intensity is increased by a factor of three by passing a current of 60 mA to the LED only during the light emitting period, then the brightness comparable to that of the lighting apparatus employing the “always on” method can be achieved. In the light source driving circuit shown in FIG. 14, if the brightness comparable to that of the lighting apparatus employing the “always on” method is to be achieved, it has been necessary to pass a current of 60 mA during the light emitting period, and this has placed a great load on the power supply. In contrast, in the lighting apparatus 2 according to the second embodiment, the charging periods t4, t6, and t8 are twice as long as the respective light emitting periods t5, t7, and t9. Accordingly, if the driving capacitor 14 is charged during each charging period with a current of 30 mA which is one half of that required in the lighting apparatus shown in FIG. 14, the charge necessary for passing a current of 60 mA during the emitting period can be accumulated on the driving capacitor 14. In this way, in the light source driving circuit 2 according to the second embodiment, the load on the power supply can be greatly reduced. If the non-emitting period is made longer, the value of the current that needs to be passed during the charging period can be further reduced.

When the light source driving circuit 2 according to the second embodiment is used for the FSC liquid crystal display apparatus, the period from t4 to t9 constitutes one frame period (T). Here, the period t4+t6, t6+t7, or t8+t9 is generally referred to as a sub-frame. The frequency (1/T) with which each of the RGB LEDs is caused to emit light is suitably chosen within the range of 60 Hz to 70 Hz. Within this range, the reproduced images can be observed as being normal and flicker-free to the human eye.

### Embodiment 3

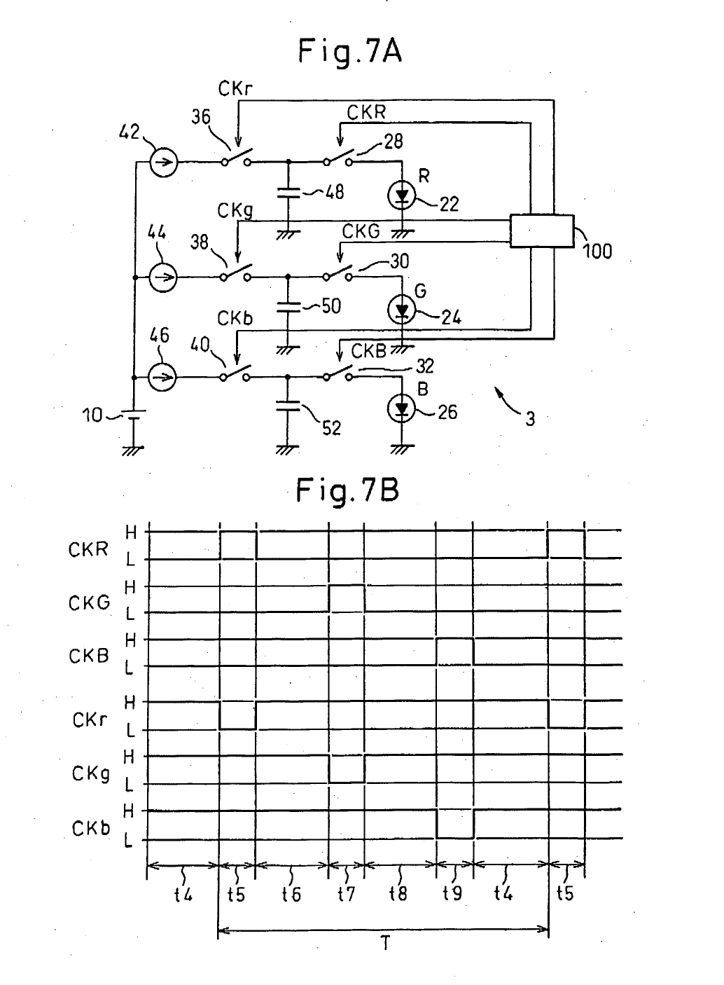

FIG. 7 shows a light source driving circuit according to a third embodiment of the present invention.

FIG. 7A is a diagram showing the basic configuration of the light source driving circuit 3 according to the third embodiment. The light source driving circuit 3 can be used for an FSC liquid crystal display apparatus. FIG. 7A differs from FIG. 1 in that, in the light source driving circuit 3 shown in FIG. 7A, for each of the color LEDs (red (R) color LED 22, green (G) color LED 24, and blue (B) color LED 26) there are provided: a constant-current circuit (R-color constant-current circuit 42, G-color constant-current circuit 44, or B-color constant-current circuit 46); a driving capacitor (R-color driving capacitor 48, G-color driving capacitor 50, or B-color driving capacitor 52); a first switch (R-color first switch 36, G-color first switch 38, or B-color first switch 40) placed between the constant-current circuit and the driving capacitor; and a second switch (R-color second switch 28, G-color second switch 30, or B-color second switch 32) placed between the driving capacitor and the LED. Here, the R-color first switch 36, the G-color first switch 38, and the B-color first switch 40 are constructed to be turned on and off under the control of the respective control signals CKr, CKg, and CKb supplied from the control section 100. Further, the R-color second switch 28, the G-color second switch 30, and the B-color second switch 32 are constructed to be turned on and off under the control of the respective control signals CKR, CKG, and CKB supplied from the control section 100.

FIG. 7B shows examples of the control signals CKr, CKg, CKb, CKR, CKG, and CKB supplied from the control section 100.

In period t4, the R-color first switch 36, the G-color first switch 38, and the B-color first switch 40 are turned on, and the R-color driving capacitor 48, the G-color driving capacitor 50, and the B-color driving capacitor 52 are charged using the power supply 10 and the respective constant-current circuits 42, 44, and 46. During this period, the R-color second switch 28, the G-color second switch 30, and the B-color second switch 32 are held OFF, thereby disconnecting the power supply 10, the constant-current circuits 42, 44, and 46, and the driving capacitors 48, 50, and 52 from the respective color LEDs 22, 24, and 26 in the light source. Here, the period t4 is the period provided for writing data to be displayed in R color on the LCD.

In the next period t5, the R-color first switch 36 is turned off, the R-color second switch 28 turned on, and the charge stored on the R-color driving capacitor 48 is discharged into the R color LED 22, thus causing the LED 22 to emit light. During this period, the G-color driving capacitor 50 and the B-color driving capacitor 52 continue to be charged. Further, during this period, the R-color first switch 36 is held OFF, thereby disconnecting the power supply 10 and the R-color constant-current circuit 42 from the LED 22. Accordingly, the power supply 10 and the R-color constant-current circuit 42 are unaffected by the discharging to the LED 22, and the system is thus maintained in a stable condition. Here, the period t5 is the period provided for displaying the image in R color on the LCD whose pixel is controlled based on the data written during the period t4.

In the next period t6, the R-color first switch 36, the G-color first switch 38, and the B-color first switch 40 are turned on, and the R-color driving capacitor 48, the G-color driving capacitor 50, and the B-color driving capacitor 52 are charged using the power supply 10 and the respective constant-current circuits 42, 44, and 46. During this period, the R-color second switch 28, the G-color second switch 30, and the B-color second switch 32 are held OFF, thereby disconnecting the power supply 10, the constant-current circuits 42, 44, and 46, and the driving capacitors 48, 50, and 52 from the respective color LEDs 22, 24, and 26 in the light source. Here, the period t6 is the period provided for writing data to be displayed in G color on the LCD.

In the next period t7, the G-color first switch 38 is turned off and the G-color second switch 30 turned on, and the charge stored on the G-color driving capacitor 50 is discharged into the G color LED 24, thus causing the LED 24 to emit light. During this period, the R-color driving capacitor 48 and the B-color driving capacitor 52 continue to be charged. Further, during this period, the G-color first switch 38 is held OFF, thereby disconnecting the power supply 10 and the G-color constant-current circuit 44 from the LED 24. Accordingly, the power supply 10 and the R-color constant-current circuit 42 are unaffected by the discharging to the LED 24, and the system is thus maintained in a stable condition. Here, the period t7 is the period provided for displaying the image in G color on the LCD whose pixel is controlled based on the data written during the period t6.

In the next period t8, the R-color first switch 36, the G-color first switch 38, and the B-color first switch 40 are turned on, and the R-color driving capacitor 48, the G-color driving capacitor 50, and the B-color driving capacitor 52 are charged using the power supply 10 and the respective constant-current circuits 42, 44, and 46. During this period, the R-color second switch 28, the G-color second switch 30, and the B-color second switch 32 are held OFF, thereby disconnecting the power supply 10, the constant-current circuits 42, 44, and 46, and the driving capacitors 48, 50, and 52 from the respective color LEDs 22, 24, and 26 in the light source. Here, the period tB is the period provided for writing data to be displayed in B color on the LCD.

In the next period t9, the B-color first switch 40 is turned off and the B-color second switch 32 turned on, and the charge stored on the B-color driving capacitor 52 is discharged into the B color LED 26, thus causing the LED 26 to emit light. During this period, the R-color driving capacitor 48 and the G-color driving capacitor 50 continue to be charged. Further, during this period, the B-color first switch 40 is held OFF, thereby disconnecting the power supply 10 and the B-color constant-current circuit 46 from the LED 26. Accordingly, the power supply 10 and the R-color constant-current circuit 42 are unaffected by the discharging to the LED 26, and the system is thus maintained in a stable condition. Here, the period t9 is the period provided for displaying the image in B color on the LCD whose pixel is controlled based on the data written during the period t8.

Thereafter, t4 to t9 are repeated, producing light in R, G, and B colors in sequence and thus accomplishing the lighting for the FSC liquid crystal display apparatus. That is, in the lighting apparatus 3 according to the third embodiment, the three driving capacitors 48, 50, and 52 are cyclically and sequentially charged by the power supply 10 and the respective constant-current circuits 42, 44, and 46.

In the light source driving circuit 3 according to the third embodiment, the current passed to obtain the brightness comparable to that of the “always on” system can be made smaller than in the light source driving circuit 2 according to the second embodiment.

Here, it is understood that, in the “always on” light source driving circuit, the three LEDs of R, G, and B are all ON and emitting light continuously. On the other hand, in the light source driving circuit 3 according to the third embodiment, the ratio of t4 to t5, the ratio of t6 to t7, and the ratio of t8 to t9, in terms of length of period, are each 3:1, as in the light. source driving circuit 2 according to the second embodiment. In this case, in the light source driving circuit 3, each of the driving capacitors 48, 50, and 52 can continue to be charged, except the emitting period of its associated LED. That is, in each of the driving capacitors 48, 50, and 52, the ratio of the discharge time to the charge time is 1:8. Accordingly, if each of the driving capacitors 48, 50, and 52 is charged with a current of 7.5 mA (=60 mA/8) during the charging period, each LED can produce brightness comparable to the corresponding LED in the “always on” light source driving circuit that uses a current of 20 mA per LED.

During the periods t4, t6, and tB, the three driving capacitors 48, 50, and 52 are charged simultaneously, while during the periods t5, t7, and t9, only two of the driving capacitors are charged; therefore, it is sufficient that the power supply 10 has a maximum current capacity of 22.5 mA (=7.5 mA×3 LEDs). This value is about one third of the current capacity of 60 mA (=20 mA×3 LEDs) required of the power supply in the “always on” light source driving circuit. It can therefore-be seen that the light source driving circuit 3 according to the third embodiment offers the effect of being able to reduce the capacity required of the power supply.

### Embodiment 4

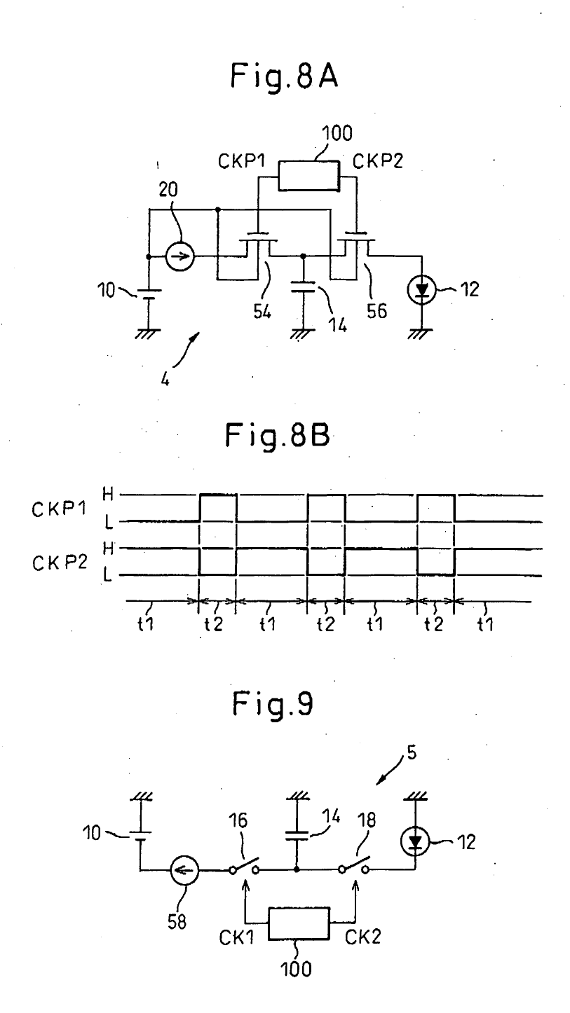

FIG. 8 shows a light source driving circuit according to a fourth embodiment of the present invention.

FIG. 8A is a diagram showing the basic configuration of the light source driving circuit 4 according to the fourth embodiment. In FIG. 8A, the first switch 16 in the light source driving circuit 1 of FIG. 1 is replaced by a P-channel MOS transistor (hereinafter abbreviated PMOST) 54, and likewise, the second switch 18 is replaced by a PMOST 56.

In FIG. 8A, the power supply 10 is connected to the input of the constant-current circuit 20 whose output is connected to the source electrode of the PMOST 54 acting as the first switch, and the drain electrode of the PMOST is connected to one terminal of the driving capacitor 14, to which is also connected the source electrode of the PMOST 56 acting as the second switch; the drain electrode of the PMOST 56 is connected to the light-emitting device 12 in the light source. The control section 100 applies a control signal CKP1 to the gate electrode of the FMOST 54 and a control signal CKP2 to the gate electrode of the PMOST 56, thereby controlling the conduction/nonconduction (ON/OFF) of the respective PMOSTs. The substrate terminals of the PMOSTs 54 and 56 are connected to the high potential side of the power supply 10 so as not to be forward-biased.

FIG. 8B shows examples of the waveforms of the control signals CKP1 and CKP2 supplied from the control section 100. Since PMOSTs are used as the switches here, each PMOST is put in a conducting (ON) state when the corresponding signal is high, and in a nonconducting (OFF) state when the signal is low. It is obvious that, when control is performed as shown in FIG. 8B, the light source driving circuit 4 according to the fourth embodiment shown in FIG. 8B operates in a manner similar to the light source driving circuit 1 according to the first embodiment shown in FIG. 1.

The lighting apparatus according to the present invention can be easily achieved by constructing the switches from transistors as described above. Further, as the constant-current circuit and the switches can all be constructed using MOS transistors, the control system of the lighting apparatus according to the present invention can be easily implemented in an integrated circuit, and thus the lighting apparatus can be made compact in size. Here, the control system of the lighting apparatus according to the present invention can be constructed using other transistors than P-channel MOS transistors, such as N-channel MOS transistors or bipolar transistors.

### Embodiment 5

FIG. 9 shows a light source driving circuit according to a fifth embodiment of the present invention.

FIG. 9 is a diagram showing the basic configuration of the light source driving circuit 5 according to the fifth embodiment. The light source driving circuit 5 according to the fifth embodiment shown in FIG. 9 is identical to the light source driving circuit 1 according to the first embodiment shown in FIG. 1, except that the voltage polarities are inverted.

In FIG. 9, the positive electrode of the power supply 10 is connected to GND, and the negative electrode of the power supply 10 is connected to the output of the constant-current circuit 58 whose input is connected to one terminal of the first switch 16; the other terminal of the first switch 16 is connected to one terminal of the driving capacitor 14, to which is also connected one terminal of the second switch 18, while the other terminal of the driving capacitor 14 is connected to GND, and the other terminal of the second switch 18 is connected to the light-emitting device 12 in the light source. The first and second switches 16 and 18 are constructed to be turned on and off under the control of the respective control signals CK1 and CK2 supplied from the control section 100.

It is obvious that the light source driving circuit according to the fifth embodiment constructed as shown in FIG. 9 operates in a manner similar to the light source driving circuit 1 according to the first embodiment shown in FIG. 1 and offers a similar effect.

### Embodiment 6

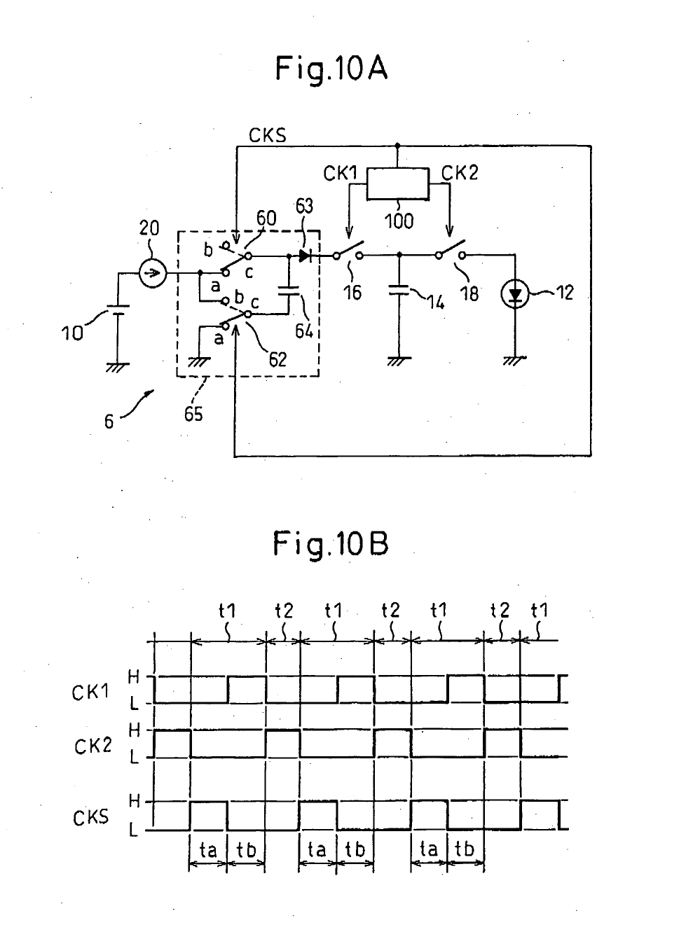

FIG. 10 shows a light source driving circuit according to a sixth embodiment of the present invention.

FIG. 10A is a diagram showing the basic configuration of the light source driving circuit 6 according to the sixth embodiment. The light source driving circuit 6 according to the sixth embodiment shown in FIG. 10A is an apparatus intended for use when the Vth of the light-emitting device 12 is higher than the supply voltage of the power supply 10. The light source driving circuit 6 according to the sixth embodiment shown in FIG. 10A differs from the light source driving circuit 1 according to the first embodiment shown in FIG. 1 by the inclusion, between the constant-current circuit 20 and the first switch 16, a voltage boosting block 65 for boosting the supply voltage to drive the light-emitting device 12 in the light source.

The boosting block 65 comprises a boosting capacitor 74, first and second two switches 60 and 62 controlled in interlinked fashion, and a diode 63. The two switches 60 and 62 are each constructed so that a common terminal “c” is connected to either a terminal “a” or a terminal “b”. The connection states of the two switches 60 and 62 are controlled by a control signal CKS supplied from the control section 100.

As shown in FIG. 10A, the output of the constant-current circuit 20 is connected to the terminal “a” of the first switch 60 as well as to the terminal “b” of the second switch 62, the terminal “b” of the first switch 60 is remained open, the terminal “a” of the second switch 62 is connected to GND, the terminal “c” of the second switch 62 is connected to one terminal of the boosting capacitor 64, and the terminal “c” of the first switch 60 is connected to the other terminal of the boosting capacitor 64 and also connected via the diode 63 to the first switch 16.

In the light source driving circuit 6 according to the sixth embodiment shown in FIG. 10A, first the contacts “c” of the switches 60 and 62 are both connected to their respective contacts “a”, and a current flows through the path provided by the power supply 10, the constant-current circuit 20, the first switch 60, the boosting capacitor 64, the second switch 62, and GND, thereby charging the boosting capacitor 64 (period ta in FIG. 10B). Next, the contacts “c” of the switches 60 and 62 are both connected to their respective contacts “b”, and the potential at the node between the boosting capacitor 64 and the diode 63 is thus set equal to the sum of the supply voltage of the power supply 10 and the voltage stored on the boosting capacitor 64 (period tb in FIG. 10B). In this condition, the first switch 16 is turned on (period tb in FIG. 10B), and the charge stored on the boosting capacitor 64 is charged into the driving capacitor 14. Here, the current flowing from the power supply 10 is limited to a relatively small value by the constant-current circuit 20; therefore, the above operation is repeated a plurality of times to charge the driving capacitor to a voltage about twice the supply voltage. That is, the voltage boosting and charging operation must be repeated by inverting the level of the signal CKS at least once within the period t1 as shown in FIG. 10B. The operation in the period t2 is the same as that shown in FIG. 2, that is, the driving capacitor 14 is discharged, causing the light-emitting device 12 to emit light.

The Vth of the LED, though it may vary depending on the current value, is approximately 2V in the case of the R-color LED and between 3V and 4V in the case of the G-color and B-color LEDs. Accordingly, when the supply voltage of the power supply 10 is small, the voltage boosting block 65 is added and the supply voltage is boosted as described above; in this way, the same effect and advantage as previously described according to the present invention can be obtained.

### Embodiment 7

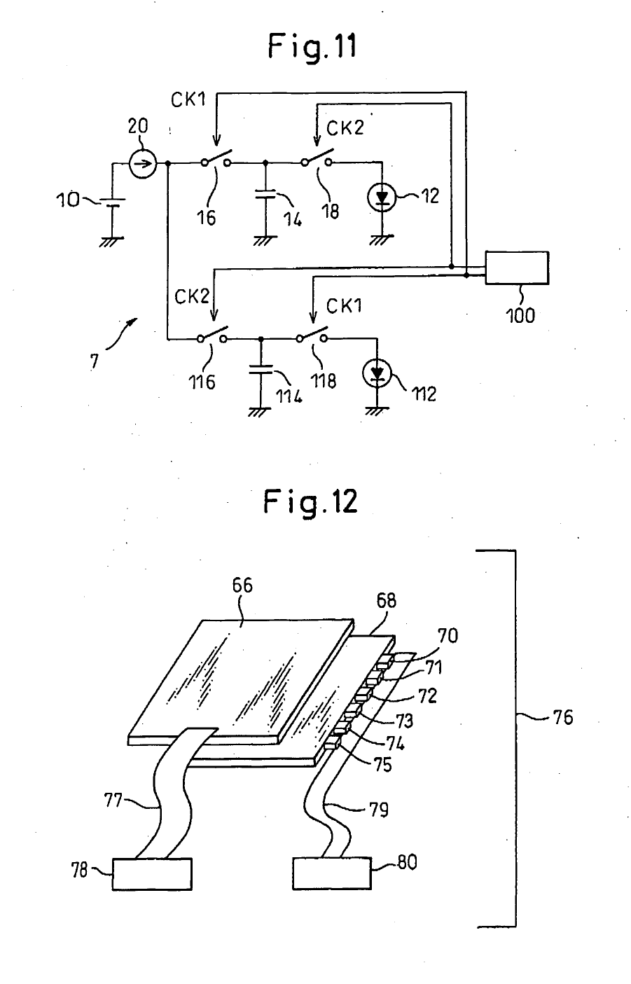

FIG. 11 shows a light source driving circuit according to a seventh embodiment of the present invention.

The light source driving circuit 7 according to the seventh embodiment shown in FIG. 11 is constructed using two circuits, each being identical to the one forming a major portion of the light source driving circuit 1 according to the first embodiment and comprising a driving capacitor, an LED, and switches. In FIG. 11, the power supply 10 is connected to the input of the constant-current circuit 20 whose output is connected to one terminal of the first switch 16, and the other terminal of the first switch 16 is connected to one terminal of the driving capacitor 14, to which is also connected one terminal of the second switch 18; the other terminal of the second switch 18 is connected to the light-emitting device 12 in the light source. The first and second switches 16 and 18 are constructed to be turned on and off under the control of the respective control signals CK1 and CK2 supplied from the control section 100.

Further, in FIG. 11, the output of the constant- current circuit 20 is connected to one terminal of the third switch 116, and the other terminal of the third switch 116 is connected to one terminal of the driving capacitor 114, to which is also connected one terminal of the fourth switch 118; the other terminal of the fourth switch 118 is connected to the light-emitting device 112 in the light source. The third and fourth switches 116 and 118 are constructed to be turned on and off under the control of the respective control signals CK1 and CK2 supplied from the control section 100.

Here, the ratio of the ON time to the OFF time of the control signal CK1 and the ratio of the ON time to the OFF time of the control signal CK2 (the period t1 and period t2 in FIG. 2) can be chosen suitably. However, if it is desired that both the light-emitting devices 12 and 112 produce light of the same intensity, the ON time and the OFF time should be set equal to each other. Further, in the lighting apparatus 7 according to the seventh embodiment, a period during which the control signals CK1 and CK2 are both set OFF may be provided between the ON period of the control signal CK1 and the ON period of the control signal CK2. In the light source driving circuit 7 according to the seventh embodiment, LEDs are used as the light-emitting devices 12 and 112 in the light source.

In the light source driving circuit 7 according to the seventh embodiment, as the control is performed as described above, the light-emitting devices 12 and 112 turn on alternately so that the light source can be observed as if it were continuously emitting light. Here, in the light source driving circuit 7 according to the seventh embodiment, by controlling the control signals CK1 and CK2 so that the light source can be observed as a emitting light source, the light source can be emitted in various ways. This offers the effect, for example, of being able to achieve a variety of kinds of displays. Further, in the light source driving circuit 7 according to the seventh embodiment, as a plurality of circuits, each identical to the one used in the light source driving circuit 1 according to the first embodiment, are used in conjunction with a single power supply, not only can the light-emitting state of the light source be controlled with greater freedom, but the power supply can be used effectively without having to let the power supply sit idle.

In the light source driving circuit 7 according to the seventh embodiment, the constant-current source 20 may be omitted, but it is preferable to include the constant-current source 20 in order to ensure that the driving capacitors 14 and 114 are properly charged or in order to enhance the reliability of the driving capacitors.

Further, the light source driving circuit 7 according to the seventh embodiment has been constructed using two circuits each comprising the first and second switches, the driving capacitor, and the light-emitting device, but it may be constructed using three or more such circuits.

The light source driving circuit 7 according to the seventh embodiment is an extension of the light source driving circuit 1 according to the first embodiment, but it will be recognized that such an extension can also be applied to other embodiments of the present invention. When such an extension is applied to other embodiments of the present invention, a similar effect to that achieved in the seventh embodiment can be obtained.

FIG. 12 shows one example of an FSC liquid crystal display apparatus that uses the light source driving circuit according to the present invention.

The FSC liquid crystal display apparatus 76 shown in FIG. 12 comprises: a liquid crystal panel 66; a light guide plate 68; a drive control circuit 78 for the liquid crystal panel 66; an interconnecting member (for example, a flexible printed circuit board (FPC) or a flat cable or wire) 77 for interconnecting the liquid crystal panel 66 and the drive control circuit 78; R-color LEDs 70 and 73; G-color LEDs 71 and 74; B-color LEDs 72 and 75; an LED control circuit 80 containing a power supply, a constant-current circuit, a driving capacitor, a first switch, a second switch, a control section, etc.; and an interconnecting member 79. Here, the light guide plate 68, the LEDs 70 to 75, the interconnecting member 79, and the control circuit 80 together constitute the light source driving circuit or the lighting apparatus according to the present invention, However, the light source driving circuit may be constructed by adding other components or by omitting some of the component elements. The FSC liquid crystal display apparatus 76 using the light source driving circuit according to the present invention as described above permits the use of a compact and high-efficiency power supply, and is particularly suitable for use in a portable apparatus.

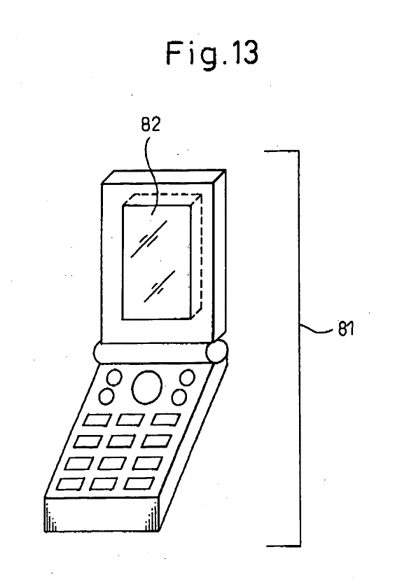

FIG. 13 shows an information appliance that uses the light source driving circuit according to the present invention.

In FIG. 13, the FSC liquid crystal display apparatus using the light source driving circuit according to the present invention is used in the display section 82 of the information appliance which is shown as a portable telephone 81. In this way, the FSC liquid crystal display apparatus using the light source driving circuit according to the present invention, because of its low power supply noise and stable operation, is particularly suitable for use in an information appliance, such as a portable telephone or a television, that has a receiver.

What is claimed is:

1. A light source driving circuit comprising:
a power supply section;
a light source section;
a charging section for storing an electric charge provided from said power supply section;
a switching section for connecting said charging section to said power supply section or to said light source section; and
a control section for controlling said switching section so as to connect said charging section to said power supply section, thereby charging said charging section, and so as to disconnect said charging section from said power supply section and connect said charging section to said light source section, thereby causing said light source section to emit light.

2. The light source driving circuit according to claim 1, wherein a non-emitting period, which includes a period during which said charging section is connected to said power supply section for charging, is set longer than an emitting period during which said light source section is caused to emit light.

3. The light source driving circuit according to claim 1, wherein said switching section includes a first switch and a second switch, and wherein
said power supply section is connected to said charging section via said first switch, and said light source section is connected to said charging section via said second switch.

4. The light source driving circuit according to claim 3, wherein said first switch and said second switch each have a control terminal, and wherein
said first switch and said second switch are controlled so as to conduct cyclically and in an alternating drive by a control signal that said control section applies to said each control terminal.

5. The light source driving circuit according to claim 4, wherein said power supply section includes a constant-current circuit, and wherein
said power supply section charges said charging section via said constant-current circuit.

6. The light source driving circuit according to claim 5, wherein said charging section includes a driving capacitor.

7. The light source driving circuit according to claim 6, wherein said light source section includes a light-emitting diode.

8. The light source driving circuit according to claim 1, wherein said light source section includes a first light source for emitting first color light, a second light source for emitting second color light, and a third light source for emitting third color light.

9. The light source driving circuit according to claim 8, wherein said switching section includes a first switch, a second switch, a third switch, and a fourth switch, and wherein
said power supply section is connected to said charging section via said first switch, said first light source is connected to said charging section via said second switch, said second light source is connected to said charging section via said third switch, and said third light source is connected to said charging section via said fourth switch.

10. The light source driving circuit according to claim 9, wherein said first switch, said second switch, said third switch, and said fourth switch each have a control terminal, and wherein
said first switch, said second switch, said third switch, and said fourth switch are controlled so as to conduct cyclically and in an alternating drive by a control signal that said control section applies to said each control terminal.

11. The light source driving circuit according to claim 10, wherein said power supply section includes a constant-current circuit, and wherein
said power supply section charges said charging section via said constant-current circuit.

12. The light source driving circuit according to claim 1, wherein said light source section includes a first light source for emitting first color light, a second light source for emitting second color light, and a third light source for emitting third color light, and
said charging section includes a first driving capacitor corresponding to said first light source, a second driving capacitor corresponding to said second light source, and a third driving capacitor corresponding to said third light source.

13. The light source driving circuit according to claim 12, wherein said switching section includes a first switch, a second switch, a third switch, a fourth switch, a fifth switch, and a sixth switch, and wherein
said power supply is connected to said first driving capacitor via said first switch, said power supply is connected to said second driving capacitor via said second switch, said power supply is connected to said third driving capacitor via said third switch, said first light source is connected to said first driving capacitor via said fourth switch, said second light source is connected to said second driving capacitor via said fifth switch, and said third light source is connected to said third driving capacitor via said sixth switch.

14. The light source driving circuit according to claim 13, wherein said first switch, said second switch, said third switch, said fourth switch, said fifth switch, and said sixth switch each have a control terminal, and wherein
said first switch, said second switch, said third switch, said fourth switch, said fifth switch, and said sixth switch are controlled so as to conduct cyclically and in an alternating drive by a control signal that said control section applies to said each control terminal.

15. The light source driving circuit according to claim 14, wherein said power supply section includes a constant-current circuit, and wherein
said power supply section charges said first driving capacitor, said second driving capacitor, and said third driving capacitor via said constant-current circuit.

16. A lighting apparatus which uses a light source driving circuit according to claim 8.

17. A display apparatus which uses a light source driving circuit according to claim 8.

18. A field sequential color liquid crystal display apparatus which uses a light source driving circuit according to claim 8.

19. An information appliance which uses a light source driving circuit according to claim 8.
